(19) United States
(12) Patent Application Publication
(10) Pub. No.: US 2006/0022620 A1
(43) Pub. Date: Feb. 2, 2006

(54) Series speed manipulation for dual fan module

(75) Inventor: Alex Gubbels, Ontario (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Inc.

(21) Appl. No.: 11/136,929

(22) Filed: May 25, 2005

Related U.S. Application Data
(60) Provisional application No. 60/591,469, filed on Jul. 27, 2004.

(51) Int. Cl. H02P 7/36

(52) U.S. Cl. 318/66; 318/139

(57) ABSTRACT

A method is provided for controlling speed of motors of a dual fan engine-cooling module. The method provides a dual fan engine cooling module 10 having first and second motors, 12 and 14, respectively. Each motor is constructed and arranged to drive a fan 13. The method ensures that the motors can be selectively connected 1) in series to provide a first speed of operation of each motor, with an output of the first motor being electrically connected with an input of the second motor by wire 20, 22, and 2) in parallel to provide a second speed of operation of each motor, the second speed of operation being greater than the first speed of operation. A resistance of the wire 20, 22 is manipulated to adjust a voltage that passes through each motor to control the first speed of each motor when the motors are connected in series.

This Application is based in U.S. Provisional Application No. 60/591,469 filed on Jul. 27, 2004 and claims the benefit thereof for priority purposes.

### BACKGROUND OF THE INVENTION

Electric engine cooling fan modules have become standard in most automobiles with front wheel drive. Depending on the application, single and dual fan engine cooling modules are used to provide engine cooling.

Dual engine cooling fan modules have been in automobiles since the advent of electro-drive cooling fan modules in the previous decades. Single speed and dual speed variations of these modules exist which are capable of varying the amount of airflow delivered to engine through the switching arrangement of the motors. One such arrangement is the so called “series/parallel configuration” which uses relays to switch motors from a parallel connection to a series connection in order to achieve full speed and reduced speed operation.

Although the series/parallel configuration works well for its intended purpose, there is a need to improve this configuration so as to tune wire resistance used in operating the motors to the speed requirements of a particular application.

### SUMMARY OF THE INVENTION

An object of the invention is to fulfill the need referred to above. In accordance with the principles of the present invention, this objective is achieved by providing a method for controlling speed of motors of a dual fan engine-cooling module. The method provides a dual fan engine-cooling module having first and second motors. Each motor is constructed and arranged to drive a fan. The method ensures that the motors can be selectively connected 1) in series to provide a first speed of operation of each motor, with an output of the first motor being electrically connected with an input of the second motor by wire, and 2) in parallel to provide a second speed of operation of each motor, the second speed of operation being greater than the first speed of operation. A resistance of the wire is manipulated to adjust a voltage that passes through each motor to control the first speed of each motor when the motors are connected in series.

In accordance with another aspect of the invention, a dual fan engine-cooling module includes first and second motors. Each motor is constructed and arranged to drive a fan. A switching arrangement is constructed and arranged to ensure that the motors can be selectively connected 1) in series to provide a first speed of operation of each motor, and 2) in parallel to provide a second speed of operation of each motor, the second speed of operation being greater than the first speed of operation. Wire electrically connects an output of the first motor with an input of the second motor when the motors are connected in series. A resistance of the wire contributes to define a voltage that passes through each motor to control the first speed of each motor when the motors are connected in series. The voltage that passes through the first motor is V₁=V_{applied}·R₁/(R₁+R₂+R₃). The voltage that passes through the second motor is V₂=V_{applied}·R₂/(R₁+R₂+R₃), where V_{applied} is an operating voltage applied to the motor by a power source, R₁ is the internal resistance of the first motor, R₂ is the internal resistance of the second motor, and R₃ is the resistance of the wire. The wire is constructed and arranged to define R₃ due to one of a material, a gauge, and a length of the wire so as to provide a certain resistance value of R₃ less than a value of R₁ and a value of R₂.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWING

The invention will be better understood from the following detailed description of the preferred embodiments thereof, taken in conjunction with the accompanying drawing, wherein like reference numerals refer to like parts, in which:

FIG. 1 is a circuit diagram of a dual engine cooling fan module provided in accordance with the principles of the present invention.

### DETAILED DESCRIPTION OF THE EXEMPLARY EMBODIMENT

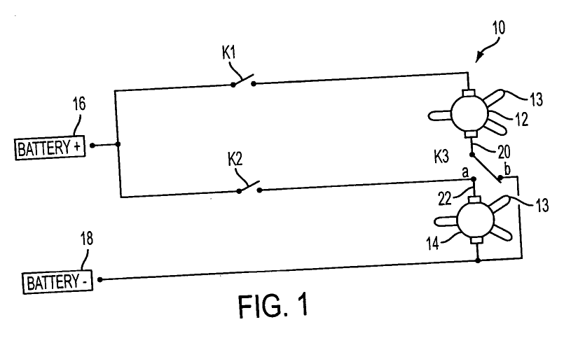

With reference to FIG. 1, a circuit diagram of a dual engine cooling fan module is shown, generally indicated at 10, in accordance with the principles of the present invention. The module 10 includes a first motor 12 and a second motor 14 connected in a series/parallel configuration to provide two speeds of operation of the module 10. Each motor 12 and 14 drives an associated fan 13 in the conventional manner.

As shown in FIG. 1, a first relay K1 is provided between a positive lead 16 of a power source and in a positive input to the first motor 12 to control power to the first motor 12. A second relay K2 is provided between the positive lead 16 of the power source and a positive input to the second motor 14. A third relay K3 is selectively provided between an output of the first motor 12 and an input of the second motor 14, and between and output of the first motor 12 and a negative lead 18 of the power source. Although relays have been described, it can be appreciated that that K1, K2 and K3 can be any conventional switching devices.

A high-speed operation of the module 10 is provided through a parallel connection of the two motors 12 and 14. With reference to FIG. 1, this high-speed operation is achieved by closing relays K1 and K2 such that the positive battery (power source) voltage 16 is applied to each of the motors 12 and 14. The output of each motor is connected to the ground (negative battery voltage 18) with relay K3 at contact “b”.

A low-speed operation of the module 10 is achieved by connecting the two motors 12 and 14 in series. With reference to FIG. 1, this low-speed operation is achieved by closing relay K1 to supply positive battery voltage to motor 12. The output of motor 12 is connected to the input of motor 14 by causing relay K3 to be at contact “a”. Relay K2 is open.

The series speed of both of the motors 12 and 14 and therefore the amount of airflow for cooling purposes is determined by a voltage divider circuit consisting of three resistances. The first resistance value (R₁) is the internal resistance of the motor 12. The second resistance (R₂) value is the internal resistance of the second motor 14. The third resistance (R₃) is the resistance of the wire (e.g., wires 20 and 22) used to connect the motors 12 and 14 is series. V_{applied} in the formulas below is an operating voltage applied to the motor (e.g., 12 volts).

The amount of voltage that passes through each fan motor is:
V₁=V_{applied}·R₁/(R₁+R₂+R₃)
and
V₂=V_{applied}·R₂/(R₁+R₂+R₃)

In accordance with the embodiment, by manipulating R₃, the resistance value of the series wire (e.g., wires 20, 22) connecting the two motors 12 and 14, one can adjust the amount of voltage that passes through each motor, and therefore control to some degree the speed and hence airflow of each motor 12 and 14.

The wire resistance can be controlled by the selection of material, gauge size, and length of wire.

### EXAMPLE 1

### Traditional Series Circuit

Suppose:

R₁=R₂=0.1 ohms
R₃=0.2 ohms
V_{applied}=12 volts

$$Therefore , \begin{matrix}{V}_{1} = {V}_{applied} \cdot {R}_{1} / ( {R}_{1} + {R}_{2} + {R}_{3} ) \\ = ( {0.1}^{*} 12 ) / ( 0.1 + 0.1 + 0.2 ) \\ = 3 volts\end{matrix}$$

Similarly, V₂=3 volts

Under a series circuit with each motor receiving 3 volts, both of the motors will be running at 25% of their 12 volts designed speed.

By manipulating R₃ to reduce the wire resistance between the output of M1 and the input of M2, the voltage seen by each motor would increase. This can be achieved by utilizing a lower resistance wire material, increasing the wire gauge, or decreasing the length of wire (e.g., wires 20, 22).

### EXAMPLE 2

### Proposed Series Circuit

Suppose:

R₁=R₂=0.1 ohms
R₃=0.05 ohms
V_{applied}=1 2 volts

$$Therefore , \begin{matrix}{V}_{1} = {V}_{applied} \cdot {R}_{1} / ( {R}_{1} + {R}_{2} + {R}_{3} ) \\ = ( {0.1}^{*} 12 ) / ( 0.1 + 0.1 + 0.05 ) \\ = 4.8 volts\end{matrix}$$

Similarly, V₂=4.8 volts

Under the proposed series circuit each motor would receive 4.8 volts. Thus, both motors will be running at 40% of their 12 volts designed speed.

Under this example, each motor is running 15% faster than in Example 1. With fan speed proportional to airflow and by manipulating the resistance of the wire in series as in Example 2, the fan module 10 is able to deliver 15% more airflow in a series circuit.

Thus, with the disclosed embodiment, there is no need for more costly speed control mechanisms such as resistors, MOSFETs for pulse width modulation, etc. In addition, there is an ability to fine-tune the wire resistance to the speed (airflow and noise) requirements for a particular application.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A method of controlling speed of motors of a dual fan engine cooling module, the method including:
providing a dual fan engine-cooling module having first and second motors, each motor being constructed and arranged to drive a fan,
ensuring that the motors can be selectively connected 1) in series to provide a first speed of operation of each motor, with an output of the first motor being electrically connected with an input of the second motor by wire, and 2) in parallel to provide a second speed of operation of each motor, the second speed of operation being greater than the first speed of operation, and
manipulating a resistance of said wire to adjust a voltage that passes through each motor to control the first speed of each motor when the motors are connected in series.

2. The method of claim 1, wherein the voltage that passes through the first motor is V₁=V_{applied}·R₁/(R₁+R₂+R₃) wherein the voltage that passes through the second motor is V₂=V_{applied}·R₂/(R₁+R₂+R₃), where V_{applied} is an operating voltage applied to the motor by a power source, R₁ is the internal resistance of the first motor, R₂ is the internal resistance of the second motor, and R₃ is the resistance of said wire, the selecting step including defining R₃ by selecting one of a material, gauge, and length of said wire to provide a certain resistance value of R₃ less than a value of R₁ and a value of R₂.

3. The method of claim 1, wherein the ensuring step includes the provision of 1) a first switch between a positive lead of a power source and in a positive input to the first motor, 2) a second switch between the positive lead of the power source and a positive input to the second motor, and 3) a third switch selectively movable between a first position connecting an output of the first motor with an input of the second motor, and a second position connecting the output of the first motor to ground, wherein the second speed of operation of each motor is provided by closing the first and second switches so that positive voltage from the source is applied to each of the first and second motors with the output of each motor being connected to ground, with the third switch disposed in the second position thereof.

4. The method of claim 3, wherein the first speed of operation of each motor is provided by closing the first switch to supply positive voltage from the source to the first motor, moving the third switch to the first position thereof so that the output of the first motor is connected to the input of the second motor and ensuring that the second switch is open.

5. The method of claim 4, wherein the third switch is electrically connected with said wire.

6. A dual fan engine cooling module comprising:
first and second motors, each motor being constructed and arranged to drive a fan,
a switching arrangement constructed and arranged to ensure that the motors can be selectively connected 1) in series to provide a first speed of operation of each motor, and 2) in parallel to provide a second speed of operation of each motor, the second speed of operation being greater than the first speed of operation, and
wire electrically connecting an output of the first motor with an input of the second motor when the motors are connected in series, a resistance of the wire contributing to define a voltage that passes through each motor to control the first speed of each motor when the motors are connected in series,
wherein the voltage that passes through the first motor is V₁=V_{applied}·R₁/(R₁+R₂+R₃), wherein the voltage that passes through the second motor is V₂=V_{applied}·R₂/(R₁+R₂+R₃), where V_{applied} is an operating voltage applied to the motor by a power source, R₁ is the internal resistance of the first motor, R₂ is the internal resistance of the second motor, and R₃ is the resistance of said wire, the wire being constructed and arranged to define R₃ due to one of a material, a gauge, and a length of said wire so as to provide a certain resistance value of R₃ less than a value of R₁ and a value of R₂.

7. The module of claim 6, wherein switching arrangement comprises 1) a first switch between a positive lead of a power source and in a positive input to the first motor, 2) a second switch between the positive lead of the power source and a positive input to the second motor, and 3) a third switch selectively movable between a first position connecting an output of the first motor with an input of the second motor, and a second position connecting the output of the first motor to ground, wherein the switching arrangement ensures the second speed of operation of each motor upon closing the first and second switches so that positive voltage from the source is applied to each of the first and second motors with the output of each motor being connected to ground, with the third switch disposed in the second position thereof.

8. The module of claim 7, wherein switching arrangement ensures the first speed of operation of each motor upon closing the first switch to supply positive voltage from the source to the first motor, moving the third switch to the first position thereof so that the output of the first motor is connected to the input of the second motor and ensuring that the second switch is open.

9. The module of claim 8, wherein the third switch is electrically connected with said wire.

10. The module of claim 6, wherein the first and second motors are each 12 volt motors such that V_{applied} is 12 volts for each of the first and second motors.

11. A dual fan engine cooling module comprising:
first and second motors, each motor being constructed and arranged to drive a fan,
means for ensuring that the motors can be selectively connected 1) in series to provide a first speed of operation of each motor, and 2) in parallel to provide a second speed of operation of each motor, the second speed of operation being greater than the first speed of operation, and
wire means for electrically connecting an output of the first motor with an input of the second motor when the motors are connected in series, a resistance of the wire means contributing to define a voltage that passes through each motor to control the first speed of each motor when the motors are connected in series,
wherein the voltage that passes through the first motor is V₁=V_{applied}·R₁/(R₁+R₂+R₃), wherein the voltage that passes through the second motor is V₂=V_{applied}·R₂/(R₁+R₂+R₃), where V_{applied} is an operating voltage applied to the motor by a power source, R₁ is the internal resistance of the first motor, R₂ is the internal resistance of the second motor, and R₃ is the resistance of said wire means, the wire means being constructed and arranged to define R₃ due to one of a material, a gauge, and a length of said wire means so as to provide a certain resistance value of R₃ less than a value of R₁ and a value of R₂.

12. The module of claim 11, wherein means for ensuring comprises 1) a first switch between a positive lead of a power source and in a positive input to the first motor, 2) a second switch between the positive lead of the power source and a positive input to the second motor, and 3) a third switch selectively movable between a first position connecting an output of the first motor with an input of the second motor, and a second position connecting the output of the first motor to ground, wherein the switches ensure the second speed of operation of each motor upon closing the first and second switches so that positive voltage from the source is applied to each of the first and second motors with the output of each motor being connected to ground, with the third switch disposed in the second position thereof.

13. The module of claim 12, wherein switches ensure the first speed of operation of each motor upon closing the first switch to supply positive voltage from the source to the first motor, moving the third switch to the first position thereof so that the output of the first motor is connected to the input of the second motor and ensuring that the second switch is open.

14. The module of claim 13, wherein the third switch is electrically connected with said wire means.

15. The module of claim 11, wherein the first and second motors are each 12 volt motors such that V_{applied} is 12 volts for each of the first and second motors.
